(19) United States
(12) Patent Application Publication
(10) Pub. No.: US 2006/0265937 A1
(43) Pub. Date: Nov. 30, 2006

(54) Drift fishing rig

(76) Inventor: Paul Randall, Anacortes, WA (US)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 11/433,785

(22) Filed: May 12, 2006

Related U.S. Application Data
(60) Provisional application No. 60/680,739, filed on May 12, 2005.

(51) Int. Cl. A01K 85/00; A01K 91/00

(52) U.S. Cl. 43/43.15; 43/42.39; 43/43.1

(57) ABSTRACT

An arrangement of fishing tackle in which a line has a hook coupled to a first end of the line, a swivel or other device for attaching a second end of the line to a main line, and a weighted lure slidably mounted on the line, the weighted lure sized in the range of 1/8 oz. to 1.2 oz., having a substantially spherical configuration, and a color scheme for attracting fish. Ideally the weighted lure can slide along the line from the hook to the swivel.

### CROSS-REFERENCE TO RELATED APPLICATION

This application claims the benefit under 35 U.S.C. § 119(e) of U.S. Provisional Patent Application No. 60/680,739 filed May 12, 2005, where this provisional application is incorporated herein by reference in its entirety.

### BACKGROUND OF THE INVENTION

1. Field of the Invention

The present invention is directed to fishing tackle and, more particularly, to a weighted fishing lure and a corresponding drift fishing rig and method of use for catching fish.

2. Description of the Related Art

Drift fishing is a common technique used for catching fish, such as steelhead, salmon, and trout. Generally, a bait is rigged on a hook with an attractor such as a corky, yarn, or the like, and weighed down with a lead weight to be cast upstream in a river. The baited hook is then allowed to drift down the river, preferably just off the bottom or bouncing along the bottom, to travel with the current. Some fishermen utilize a float to assist in holding the bait above the bottom of the river for better presentation and to avoid snags.

Because this technique involves fishing on or near the bottom of a moving body of water, a substantial amount of terminal tackle, i.e., hooks, weights, and swivels, are lost to snagging on the bottom of the river or on objects resting on the bottom, such as branches, plant life, and the like.

Much of drift fishing involves making the most “natural” presentation to the fish and being able to detect a bite, which most frequently can be very subtle and often difficult to distinguish from the bait or the weight bouncing along the river bottom. A typical drift fishing setup 10 is illustrated in FIG. 1 where a main line 12 of preferably 10 to 20 lb. test strength is coupled to a leader line of preferably 6to 17 lb. test via a swivel 16, preferably a barrel swivel. The free end of the leader line 14 is attached to a hook 18, in many instances with an egg loop knot 20 that facilitates the attachment of bait, yarn, etc. to the hook 18. A sliding weight 22 is used on the main line 12. As shown in FIG. 1, the weight 22 is coupled to the main line 12 via a small snap swivel 24 attached to surgical tubing 26 in which a solid core lead weight 28 is slidably received. To help hold the hook 18 above the bottom of the stream, a flotation device 30, such as a bobber, corky or a cheater can be used on the leader 14. In some fishing rigs, the flotation device 30 is allowed to slide along the length of the leader line 14.

Because steelhead are very sensitive to a leader, the most common leader is a fluorocarbon line in the range of 6 to 10 lb. test. This means the line will not break when subjected to a load of 6 to 10 lbs. of weight. Typical leader lengths are 30 to 45 inches long. On the other hand, when fishing for salmon, leader line strengths should be in the range of 20 to 30 lbs. test where appropriate.

The fishing setup 10 is typically used with a casting rod and reel where it is cast out and upstream at approximately a 30 to 45° angle. The objective is to have the bait travel near the bottom of the stream as it flows past the fisherman. The weight should touch the bottom of the stream on a regular basis, preferably every 5 to 10 feet. If this does not occur, then additional weight needs to be added. On the other hand, if the hook and bait are dragging along the bottom, then weight needs to be removed.

Often a steelhead will follow the bait downriver, gently picking it up, mouthing it, and spitting it out without the fisherman detecting the activity. Because there is usually 2 to 3 feet of leader on the other side of the weight, even if a fish has taken the bait and remained stationary, it will take time for the weight to travel past the fish before the bite is detected. This disadvantage provides sufficient time for a fish to test and spit out the bait.

### BRIEF SUMMARY OF THE INVENTION

The disclosed embodiments of the present invention are directed to a drift fishing rig that overcomes the disadvantages of existing setups and enhances the attraction of fish to the bait and hook, reduces snagging, and is suitable for all game fish. In addition, it enables fishermen to present bait from the surface down as opposed to corkies, cheaters, and the like, which come from the bottom up. This results in less loss of gear.

In accordance with one embodiment of the invention, a lure is provided that includes a weighted body having an opening formed therethrough, the body painted to have at least one color. Ideally the body has a spherical shape and is sized in the range of 1/16 oz. to 1.2 oz. The color can be a solid color selected from black, red, yellow, orange, purple, green, and pink, or half yellow and half green, half yellow and half red, or having spots thereon, preferably black spots or speckles.

In accordance with another embodiment of the invention, an arrangement of fishing equipment is provided that includes a line, means for hooking coupled to a first end of the line, means for attaching coupled to a second end of the line, and a weighted lure slidably mounted on the line, the weighted lure sized in the range of ⅛ oz. to 1.2 oz., having a substantially spherical configuration, and a color scheme for attracting fish.

In accordance with another aspect of the present invention, the color scheme is selected according to water clarity, time of year, and species of fish.

In accordance with another embodiment of the invention, a drift fishing rig is provided that includes a main line having a bobber coupled thereto, a leader line attached to the main line via a swivel, a hook coupled to a free end of the leader line, and a weighted lure slidably mounted to the leader line, the weighted lure having a size in the range of 1/16 oz. to 1.2 oz., having a substantially spherical configuration, and a color scheme for attracting fish.

As will be readily appreciated from the foregoing, the disclosed embodiments of the present invention enable a fisherman to use bait in a variety of color patterns at a controlled depth by means of a slip float or adjustable float. The use of lead on the leader line allows the bait to be pulled quickly down to a desired strike zone, enables the fisherman's bait to quickly obtain and sustain the desired strike zone, combines features of a adjustability of weight and appearance, presents bait from the surface down as opposed to the bottom up as in present configurations, can be used with different kinds of bobbers and floats, can be used by itself without bait or yarn, and is suitable for all game fish.

### BRIEF DESCRIPTION OF THE SEVERAL VIEWS OF THE DRAWINGS

The foregoing and other features and advantages of the present invention will be more readily appreciated as the same become better understood from the following detailed description when taken in conjunction with the accompanying drawings, wherein:

FIG. 1 is an illustration of a known drift fishing set-up;

FIG. 2 is an illustration of a drift fishing rig formed in accordance with the present invention;

FIG. 3 is an illustration of a drift weight formed in accordance with the present invention;

FIG. 4 is a color illustration of various color schemes used in accordance with the present invention; and

FIG. 5 is an illustration of approximate sizes of the weighted lure formed in accordance with the present invention.

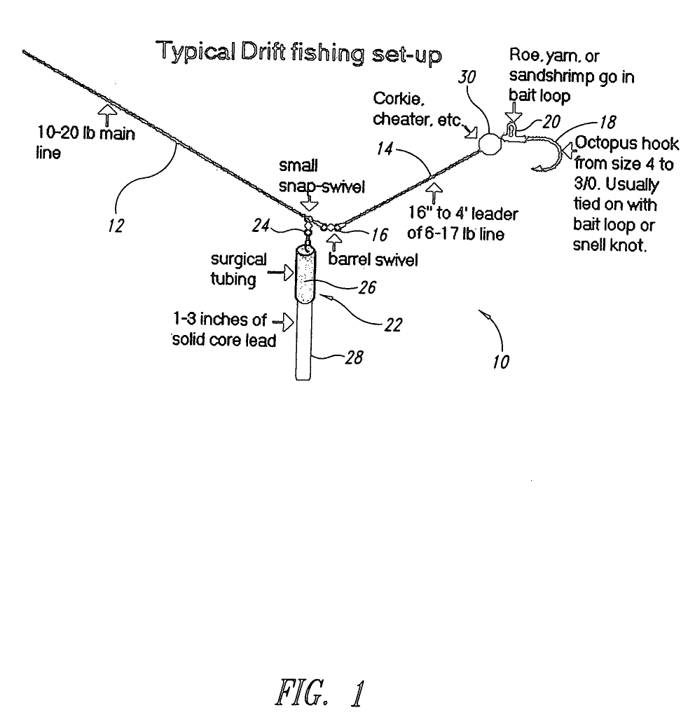

### DETAILED DESCRIPTION OF THE INVENTION

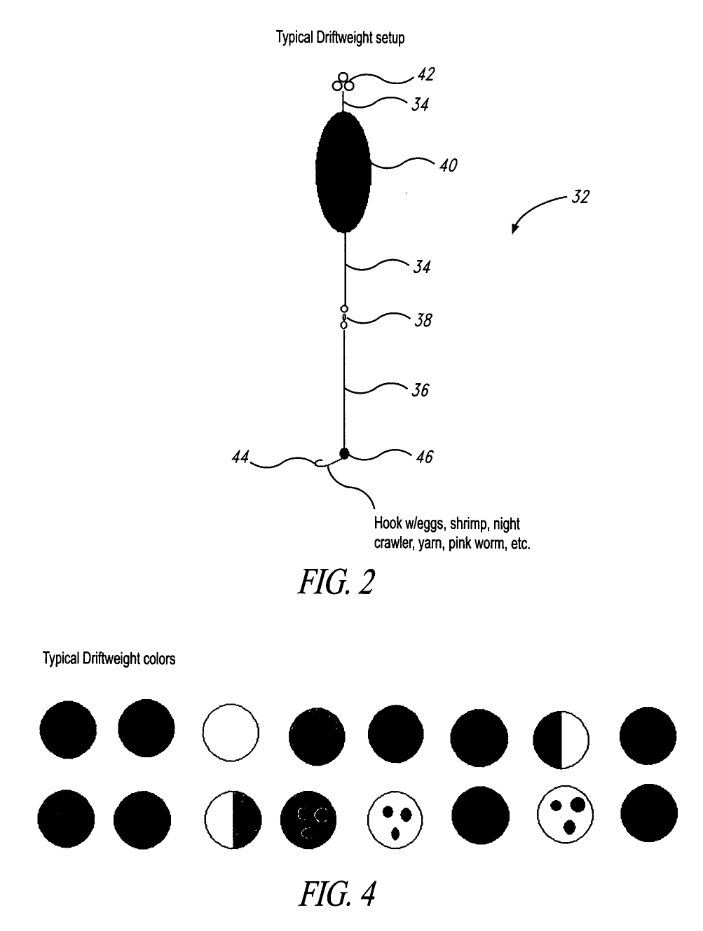

Referring initially to FIG. 2, shown therein is a drift fishing rig 32 formed in accordance with one embodiment of the present invention. A main line 34 is coupled to a leader 36 via a swivel 38, preferably a barrel swivel. Slidably mounted on the main line 34 is a bobber 40 that is limited in its travel by the swivel 38 at one end and by a stop 42 formed in the main line 34. The stop 42 ideally is formed by a mail knot tied around the main line to allow depth control.

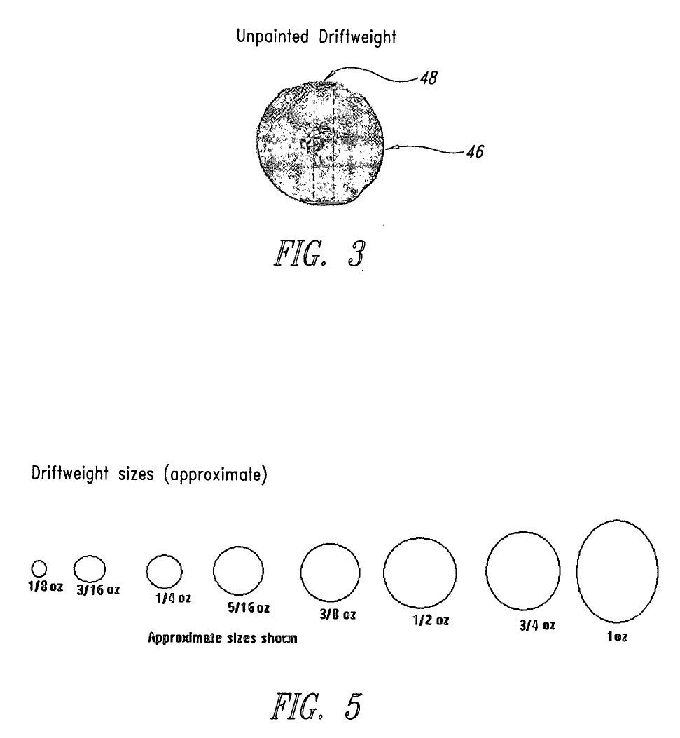

The leader 36 has a hook 44 attached to its free end, preferably with an egg loop knot that permits the tying on of bait, or attactors for fish. Bait and attactors can include eggs, shrimp, nightcrawlers, yarn, pink worms, and other known means for attracting fish. Slidably mounted on the leader 36 is the weighted lure 46, which as shown in FIG. 3 has a central opening formed therethrough and in which the leader 36 is received.

FIG. 3 shows the weighted lure 46 in an unpainted state. Preferably, the weighted lure is formed of lead, although other materials suitable for use in fresh and saltwater may be used. As can be seen therein, the preferable shape is that of a sphere, although other shapes may be used without departing from the spirit and scope of the invention. The spherical shape is a preferred embodiment inasmuch as it simulates salmon eggs and other similar bait.

In order to attract fish, the weighted lure 46 is painted or otherwise colored. The size is preferably in the range of 1/16 oz. to 1.2 oz., and more preferably in the range of ⅛ oz. to 1 oz as shown in FIG. 5. The preferred color schemes are shown in FIG. 4, including solid colors and the use of black spots. It is to be understood that other colors may be used without departing from the spirit and scope of the invention.

The size and color of the weighted lure 46 are selected based on a number of factors, including, but not limited to, water clarity, time of year, and species of fish. Another factor would be the type of bait, if any, to be used.

Ideally the leader 36 has a weight limitation or strength in the range of 3 to 60 lbs., and more preferably in the range of 5 to 50 lb. test. The length is generally in the range of 5 to 60 inches, and more preferably in the range of 10 inches to 48 inches. Various types of bobbers and floats may be used and are to be matched for the water conditions, weight size, and type of bait.

In use, the foregoing rig can be fished in a conventional manner that is well-known to those skilled in the art and which will not be described in greater detail herein. An important aspect of drift fishing and bobber fishing is to get the bait down to the desired depth as quickly as possible in order to take full advantage of the entire drift. Because the weight of the bait itself may not always be sufficient to get the bait down to the desired depth or to keep it there due to, among other things, swirling-up currents, the present invention provides a substantial improvement over previous rigs that allowed the bait to be taken completely up out of the strike zone.

From the foregoing it will be appreciated that, although specific embodiments of the invention have been described herein for purposes of illustration, various modifications may be made without deviating from the spirit and scope of the invention. Accordingly, the invention is not limited except as by the appended claims and the equivalents thereof.

1. An arrangement of fishing tackle, comprising:
a line;
means for hooking coupled to a first end of the line;
means for attaching coupled to a second end of the line; and
a weighted lure slidably mounted on the line, the weighted lure sized in the range of ⅛ oz. to 1.2 oz., having a substantially spherical configuration, and a color scheme for attracting fish.

2. The arrangement of claim 1 wherein the weighted lure comprises an opening formed therethrough in which the line is positioned so that the weighted lure can slide from the first end to the second end of the line.

3. The arrangement of claim 2 wherein the color scheme of the weighted lure is selected according to water clarity, time of year, and species of fish.

4. The arrangement of claim 1 wherein the line has a length in the range of 5 inches to 60 inches.

5. The arrangement of claim 1 wherein the line comprises leader line having a strength in the range of 3 to 60 lb. test.

6. The arrangement of claim 1 wherein the weighted lure is formed of lead material.

7. A weighted lure, comprising:
a body having an opening formed therethrough, the body sized in the range of 1/16 oz. to 1.2 oz., having a substantially spherical shape, and the entire body having a base color selected from among black, red, yellow, orange, green, pink, blue, and purple.

8. A drift fishing rig, comprising:
a main line having a bobber coupled thereto;
a leader line attached to the main line via a swivel;
a hook coupled to a free end of the leader line; and
a weighted lure slidably mounted to the leader line, the weighted lure having a size in the range of 1/16 oz. to 1.2 oz., having a substantially spherical configuration, and a color scheme for attracting fish.

9. The rig of claim 8 wherein the reader line comprises monofilament line having a strength in the range of 3 lb. test to 60 lb. test.

10. The rig of claim 8 wherein the leader line has a length in the range of 5 inches to 60 inches.

11. The rig of claim 8 wherein the weighted lure has a base color selected from among black, orange, yellow, red, blue, green, pink, and purple.

12. The rig of claim 8, further comprising bait coupled to the hook.
